(19) United States
(12) Patent Application Publication
(10) Pub. No.: US 2020/0047769 A1
(43) Pub. Date: Feb. 13, 2020

(54) VEHICLE CONTROL APPARATUS

(71) Applicant: HONDA MOTOR CO., LTD., MIlNATO-KU, TOKYO (JP)

(72) Inventors: Hiroshi OGURO, WAKO-SHI, SAITAMA-KEN (JP); Daichi KATO, WAKO-SHI, SAITAMA-KEN (JP); Kuniaki MATSUSHIMA, WAKO-SHI, SAITAMA-KEN (JP)

(21) Appl. No.: 16/342,670

(22) PCT Filed: Oct. 18, 2016
(86) PCT No.: PCT/JP2016/080780

§ 371 Date: Apr. 17, 2019

(51) Int. Cl. B60W 50/08; G05D 1/00; G05D 1/02

(52) U.S. Cl. CPC B60W 50/08; B60W 2050/007; G05D 1/0212; G05D 1/0088

(57) ABSTRACT

Provided is a vehicle control apparatus with which when autonomous driving is switched from an off state to an on state by an autonomous driving switch, the transition to autonomous driving is made according to the previous target path generated in the autonomous-driving off state or the predicted path generated on the basis of the latest vehicle state information, thereby allowing instantaneous and smooth transition from manual driving to autonomous driving.

### TECHNICAL FIELD

The present invention relates to a vehicle control device (vehicle control apparatus) suitable for being applied to a vehicle that is capable of being driven automatically (including an automated driving assist).

### BACKGROUND ART

U.S. Patent Application Publication No. 2013/0110343 (hereinafter referred to as “US2013/0110343A1”), has the object of providing a driving assist device in which, in the case that execution of automated driving is instructed by an automated driving switch, without the driver experiencing a feeling of discomfort, the device can easily be operated in an intuitive manner (see paragraph [0008], abstract).

### SUMMARY OF INVENTION

However, with the driving assist device disclosed in US2013/0110343A1, during traveling, in the case that a switch is made from manual driving to automated driving by operation of the automated driving switch, after such a switch is made, a course to be used for automated driving is generated (see paragraph [0047]).

Therefore, there is a problem in that time is required from the time at which the switching operation to automated driving of the automated driving switch is made until the time when automated driving of the vehicle is actually started, and thus a sense of discomfort is imparted to the driver or the like.

Provisionally, at the time of the switching operation, in the case that switching to automated driving is made immediately, a problem also occurs in that, due to a time delay or the like in the vehicle incorporated communication system, time is required until the vehicle behavior becomes stabilized.

The present invention has been devised taking into consideration the aforementioned problems, and has the object of providing a vehicle control device in which, during traveling, it is possible to initiate automated driving smoothly and instantaneously when a switch is made from a manual driving mode to an automated driving mode.

A vehicle control device according to the present invention comprises an environment map generating unit configured to generate environment map information based on external environment recognition information and host vehicle state information, a target trajectory generating unit configured to generate, based on the host vehicle state information and the environment map information, a target trajectory within a first period, and which is made up from a trajectory point sequence of a second period which is a divided portion of the first period, a vehicle control unit configured to perform automated driving based on the target trajectory, or to perform manual driving in accordance with driver operations, an automated/manual switching unit configured to switch between automated driving and manual driving, and an integrated control unit configured to control these elements, wherein, during traveling of the host vehicle, and after an end timing of the second period when switching from manual driving to automated driving is detected, the integrated control unit is configured to implement a control so as to perform automated driving in accordance with a predicted trajectory based on a previous instance of the target trajectory or based on most recent host vehicle state information until an end timing of the first period portion, and after the end timing of the first period portion, implement a control so as to perform automated driving along the target trajectory which is sequentially generated.

According to the present invention, during traveling, when a switch is made from manual driving to automated driving by the automated/manual switching unit, the transition to automated driving is made based on the previous instance of the target trajectory or the most recent host vehicle state information, and therefore, when transitioning from manual driving to automated driving, the transition can be made smoothly and instantaneously.

In this case, the target trajectory generating unit is configured to continuously generate the target trajectory regardless of switching of the automated/manual switching unit, and at a time of switching from manual driving to automated driving, and after the end timing of the second period and until the end timing of the first period portion, the integrated control unit may be configured to implement a control so as to perform automated driving using a remaining portion of the target trajectory that was calculated in the first period, and after the end timing of the first period portion, implement a control so as to perform automated driving along the target trajectory which is sequentially generated.

According to the present invention, at the time of switching from manual driving to automated driving by the automated/manual switching unit, the transition is made immediately to automated driving in accordance with the previously calculated target trajectory, and therefore, when transitioning from manual driving to automated driving, the transition can be made smoothly and instantaneously.

Further, before switching to automated driving by the automated/manual switching unit, the target trajectory generating unit may be configured to continuously generate the predicted trajectory based on the most recent host vehicle state information, and after switching to automated driving, may continuously generate the target trajectory. In addition, at a time of switching from manual driving to automated driving, and after the end timing of the second period and until the end timing of the first period portion, the integrated control unit may be configured to initiate automated driving in accordance with the predicted trajectory, and after the end timing of the first period portion, implement a control to continue with automated driving in accordance with the target trajectory.

According to the present invention, at the time of switching from manual driving to automated driving by the automated/manual switching unit, automated driving is initiated in accordance with the predicted trajectory generated based on the most recent vehicle state information, and thereafter, automated driving is continued in accordance with the target trajectory. Therefore, when transitioning from manual driving to automated driving, the transition can be made smoothly and instantaneously.

Furthermore, the predicted trajectory is a portion in which a time delay corresponding to at least the first period portion is expected. In this manner, by setting the predicted trajectory generated by the integrated control unit to a portion that anticipates the time delay corresponding to at least the first period portion, automated driving in accordance with the target trajectory can be continued thereafter.

Further still, there may be provided a power storage device configured to supply electrical power to the vehicle control device, wherein, in a case that a residual capacity of the power storage device is greater than or equal to a threshold residual capacity value, the vehicle control unit is preferably configured to initiate automated driving based on the target trajectory, and in a case that the residual capacity is less than the threshold residual capacity value, the vehicle control unit is preferably configured to initiate automated driving based on the predicted trajectory.

In the case that the residual capacity of the power storage device is greater than or equal to the threshold residual capacity value and there is a surplus of electrical power, the target trajectory is generated at all times during traveling, whereas in the case that the residual capacity of the power storage device is less than the threshold residual capacity value and there is not a surplus of electrical power, continuous generation of the target trajectory is prohibited, and the predicted trajectory is generated. Therefore, automated driving can be performed in accordance with the residual capacity of the power storage device. Moreover, when switching is carried out, performance of automated driving with the most recent target trajectory enables the trajectory of the vehicle to be smoother in comparison to performing automated driving with the most recently predicted trajectory.

### BRIEF DESCRIPTION OF DRAWINGS

FIG. 1 is a schematic configuration block diagram of a vehicle equipped with a vehicle control device according to a present embodiment;

FIG. 2 is an exemplary illustration of an environment map;

FIG. 3 is a flowchart provided to explain operations of the vehicle control device according to a first exemplary embodiment;

FIG. 4 is a time chart provided to explain operations of the vehicle control device according to the first exemplary embodiment;

FIG. 5 is a flowchart provided to explain operations of the vehicle control device according to a second exemplary embodiment; and

FIG. 6 is a time chart provided to explain operations of the vehicle control device according to the second exemplary embodiment.

### DESCRIPTION OF EMBODIMENTS

A preferred embodiment of a vehicle control device according to the present invention will be presented and described below with reference to the accompanying drawings, in relation to a vehicle in which the vehicle control device is installed.

### [Configuration of Vehicle 10]

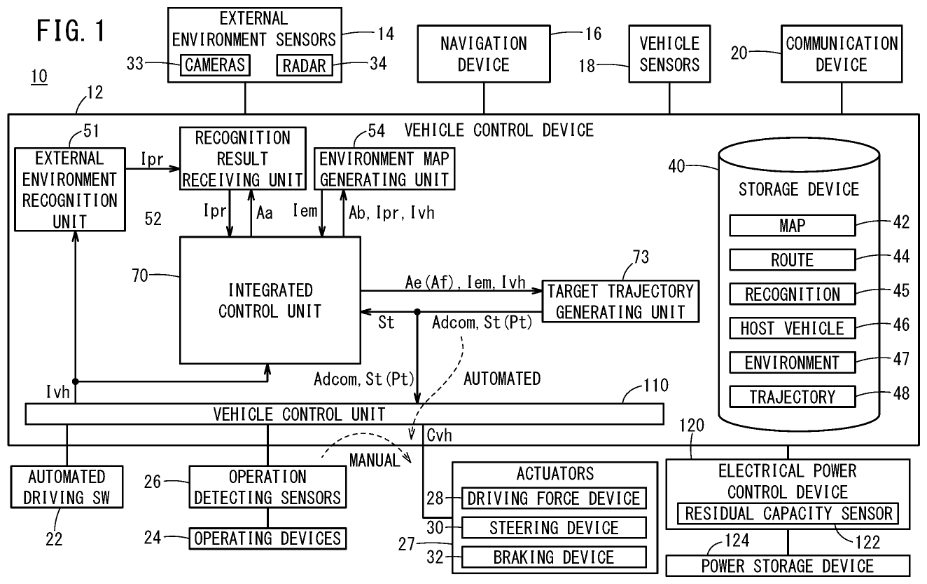

FIG. 1 is a schematic configuration block diagram of a vehicle 10 (also referred to as a “host vehicle” or a “driver's own vehicle”) equipped with a vehicle control device 12 according to a present embodiment.

The vehicle 10 includes the vehicle control device 12, and in addition to the vehicle control device 12, is equipped with input devices and output devices which are connected via communication lines to the vehicle control device 12, and a power storage device 124 in the form of a secondary battery (power supply) that supplies electrical power to the input and output devices and the vehicle control device 12.

As the input devices, there are provided external environment sensors 14, a navigation device 16, vehicle sensors 18, a communication device 20, an automated driving switch (automated driving SW) 22, operation detecting sensors 26 connected to operating devices 24, and an electrical power control device 120.

As the output devices, there are provided a driving force device 28 for driving the vehicle wheels (not shown), a steering device 30 for steering the vehicle wheels, and a braking device 32 for braking the vehicle wheels. Moreover, the navigation device 16 and the communication device 20 can also be used as input/output devices (human interface, transceiver).

### [Configuration of Input/Output Devices, etc., Connected to Vehicle Control Device 12]

The external environment sensors 14 include a plurality of cameras 33 and a plurality of radar devices 34 which acquire information indicative of the external environment (360° around the front, rear, and sides, etc.) of the vehicle 10, and output the acquired external environmental information of the vehicle 10 to the vehicle control device 12. The external environment sensors 14 may further be equipped with a plurality of LIDAR (Light Detection and Ranging; Laser Imaging Detection and Ranging) devices.

The navigation device 16 detects and specifies a current position of the vehicle 10 using a satellite positioning device or the like, together with including a touch panel display, a speaker, and a microphone as a user interface, and further, calculates a route to a designated destination from the current position or a position designated by the user, and outputs the calculated route to the vehicle control device 12. The route calculated by the navigation device 16 is stored as route information in a route information storage unit 44 of a storage device 40.

The vehicle sensors 18 output to the vehicle control device 12 detection signals from respective sensors, including a speed (vehicle speed) sensor for detecting the speed (vehicle speed), an acceleration sensor for detecting an acceleration, a lateral G sensor for detecting a lateral G force of the vehicle 10, a yaw rate sensor for detecting an angular velocity about a vertical axis of the vehicle 10, an orientation sensor for detecting an orientation of the vehicle 10, and a gradient sensor for detecting a gradient of the vehicle 10. At each of respective operation cycles Toc, to be described later, the detection signals are stored as host vehicle state information Ivh of the host vehicle in a host vehicle state information storage unit 46 of the storage device 40.

The communication device 20 communicates with roadside devices, other vehicles, and a server, etc., and receives or transmits information related to traffic signals, etc., information related to the other vehicles, as well as probe information and updated map information or the like. In addition to being stored in the navigation device 16, the map information is stored as map information in a map information storage unit 42 of the storage device 40.

The operating devices 24 include an accelerator pedal, a steering wheel (handle), a brake pedal, a shift lever, and a direction indicating (turn signal) lever, and the like. The operation detecting sensors 26, which detect the presence or absence or the operated amounts of operations made by the driver, as well as operated positions, are attached to the operating devices 24.

The operation detecting sensors 26 output to a vehicle control unit 110 as detection results an amount by which the accelerator is depressed (degree of accelerator opening), an amount (steering amount) at which the steering wheel is operated, an amount by which the brake pedal is depressed, a shift position, and a right or left turn direction, etc.

The automated driving switch (automated/manual switching unit) 22, for example, is a pushbutton switch provided on the instrument panel, and is operated manually by a user such as a driver or the like in order to switch between a non-automated driving mode (manual driving mode) and an automated driving mode.

According to the present embodiment, the automated driving mode and the non-automated driving mode are set each time that the pushbutton switch is pressed, however, in order to provide confirmation of a driver's intention to switch to automated driving, it is possible to provide settings in which, for example, switching from the non-automated driving mode to the automated driving mode is effected by pressing twice, and switching from the automated driving mode to the non-automated driving mode is effected by pressing once.

The automated driving mode is a driving mode in which the vehicle 10 travels under the control of the vehicle control device 12, in a state in which the driver does not operate the operating devices 24 such as the accelerator pedal, the steering wheel, and the brake pedal, and is a driving mode in which the vehicle control device 12 controls a portion or all of the driving force device 28, the steering device 30, and the braking device 32 on the basis of action plans (a target trajectory St or a predicted trajectory Pt, to be described later).

Moreover, during the automated driving mode, in the case that the driver starts to operate any of the operating devices 24 such as the accelerator pedal, the steering wheel, or the brake pedal, the automated driving mode is canceled automatically, and the system switches over to the non-automated driving mode (manual driving mode).

In this instance, even in the manual driving mode, certain driving assist functions, such as a known adaptive cruise control (ACC) function, and a lane keeping assist system (LKAS) function can be implemented.

Further, the aforementioned automated driving switch 22 may be of a touch type, a voice input type, or the like.

The driving force device 28 is constituted from a driving force ECU, and a drive source for the vehicle 10 such as an engine and/or a driving motor or the like. The driving force device 28 generates a travel driving force (torque) in order for the vehicle 10 to travel in accordance with vehicle control values Cvh input thereto from the vehicle control unit 110, and transmits the travel driving force to the vehicle wheels directly or through a transmission.

The steering device 30 is constituted from an EPS (electric power steering system) ECU, and an EPS device. The steering device 30 changes the orientation of the vehicle wheels (steered wheels) in accordance with the vehicle control values Cvh input thereto from the vehicle control unit 110.

The braking device 32, for example, is an electric servo brake used in combination with a hydraulic brake, and is made up from a brake ECU and a brake actuator.

The braking device 32 brakes the vehicle wheels in accordance with vehicle control value Cvh information input thereto from the vehicle control unit 110.

Moreover, steering of the vehicle 10 can also be performed by changing a torque distribution and/or a braking force distribution with respect to the left and right vehicle wheels.

The electrical power control device 120 includes a residual capacity sensor 122 that detects the residual capacity SOC of the power storage device 124, and outputs the residual capacity SOC to an integrated control unit 70.

### [Configuration of Vehicle Control Device 12]

The vehicle control device 12 is constituted by one or a plurality of ECUs (electronic control units), and is equipped with the storage device 40, etc., in addition to various function realizing units. According to the present embodiment, the function realizing units are software-based functional units, in which the functions thereof are realized by a CPU (central processing unit) executing programs stored in the storage device 40. However, the functions thereof can also be realized by hardware-based functional units made up from integrated circuits or the like.

In addition to the storage device 40 and the vehicle control unit 110 as a function realizing unit (function realizing module), the vehicle control device 12 is constituted from an external environment recognition unit 51, a recognition result receiving unit 52, an environment map generating unit (also referred to as a local environment map generating unit) 54, a target trajectory generating unit 73, and the integrated control unit (task synchronization module) 70 that controls these units comprehensively together with controlling task synchronization.

In the vehicle control device 12, the external environment recognition unit 51 simultaneously generates external environment recognition information Ipr made up from static (having no change or no movement) external environment recognition information Iprs, and dynamic (in which change or movement there of is possible) external environment recognition information Iprd.

When the static external environment recognition information Iprs is generated, the external environment recognition unit 51 refers to the host vehicle state information Ivh from the vehicle control unit 110, and furthermore, from among the external environment sensors 14, on the basis of the external environmental information (image information) from the cameras 33 and the like, recognizes lane markings (white lines) on both sides of the vehicle 10, together with recognizing the distances to stop lines of intersections or the like (how many meters there are up to the stop lines) as well as recognizing travel capable regions (planar regions in which guardrails and curbsides are excluded without concern to the lane markings), and then generates the external environment recognition information Iprs, and transmits (outputs) such information to the recognition result receiving unit 52.

When the dynamic external environment recognition information Iprd is generated, the external environment recognition unit refers to the host vehicle state information Ivh, and furthermore, on the basis of the external environmental information from the cameras 33 or the like, the external environment recognition unit 51 recognizes obstacles (including parked or stopped vehicles), traffic participants (people, other vehicles), and the colors of traffic signals (blue (green), yellow (orange), red) and the like, and then generates the external environment recognition information Iprd, and transmits (outputs) such information to the recognition result receiving unit 52.

The external environment recognition unit 51 recognizes the external environment recognition information Ipr (Ipr=Iprs+Iprsd) in a time period that is less than the operation cycle Toc, and transmits (outputs) the information to the recognition result receiving unit 52.

In this case, in response to an operation command Aa from the integrated control unit 70, the recognition result receiving unit 52 outputs the external environment recognition information Ipr (Ipr=Iprs+Iprd) received from the external environment recognition unit 51 to the integrated control unit 70 within the operation cycle Toc.

The integrated control unit 70 stores the external environment recognition information Ipr (Ipr=Iprs+Iprd) in the storage device 40.

In this instance, the operation cycle (also referred to as a reference cycle or a reference operation cycle) Toc is a standard operation cycle in the vehicle control device 12, and is set, for example, to a value on the order of several tens of ms.

In response to an operation command Ab from the integrated control unit 70, the environment map generating unit 54 refers to (aggregates) the host vehicle state information Ivh as well as the external environment recognition information Ipr, and within the operation cycle Toc, generates environment map information (also referred to as local environment map information) Iem, and outputs such information to the integrated control unit 70.

The environment map information Iem, in general, is information obtained by synthesizing the host vehicle state information Ivh with the external environment recognition information Ipr. The environment map information Iem is stored in an environment map information storage unit 47 of the storage device 40.

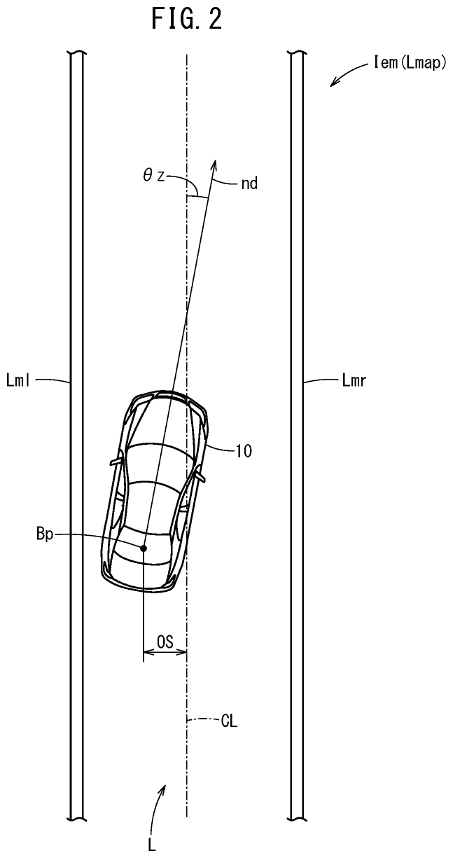

FIG. 2 shows an example of an environment map (also referred to as a local environment map) Lmap that is stored as the environment map information Iem.

In this instance, the host vehicle state information Ivh is information obtained from the vehicle control unit 110, and is basically made up from an offset amount (position) OS of a reference point Bp of the vehicle 10, for example, a midpoint of a rear wheel axle from a center line CL of the lane L (which is partitioned by a right side lane marking Lmr and a left side lane marking Lml), a posture angle (also referred to as an azimuth angle) θz which is an angle between the center line CL and a nose direction nd of the vehicle 10, a speed vs, an acceleration va, a curvature ρ of the travel line, a yaw rate γ, and a steering angle δst, etc. The offset amount OS may be expressed as coordinates {x (a longitudinal direction which is the direction of the travel path), y (a lateral direction which is a direction perpendicular to the travel path)} from a reference position (arbitrary).

More specifically, as shown in the following equation (1), the host vehicle state information Ivh is the most recent information at that point in time of a later-described trajectory point sequence Pj {refer to equation (2)}.

Ivh=Ivh(x, y, θz, vs, va, ρ, γ, δst) (1)

Pj=Pj(x, y, θz, vs, va, ρ, γ, δst), t=1, 2, . . . T (2)

The trajectory point sequence Pj is corrected until later-described trajectory candidate point sequences Pcj(x, y, θz, vs, va, ρ, γ, δst) t=1, 2, . . . T are affirmatively evaluated, to result in the trajectory point sequence Pj(x, y, θz, vs, va, ρ, γ, δst) t=1, 2, . . . T which is an output trajectory. The term “t” corresponds to the time of an integer fraction (which may be changed depending on the speed vs) of the operation cycle Toc, with 1 being a first point, and T corresponding to the length of time of the trajectory that is generated at a point of one second or the like.

In FIG. 2, the lane L (the right lane marking Lmr and the left lane marking Lml) is the external environment recognition information Ipr that is recognized (using a known type of lane marking detection, a bird's-eye transformation, and a curve approximation process) by the external environment recognition unit 51 from the image information from the cameras 33.

In this manner, the environment map information Iem (environment map Lmap) is information indicative of the surrounding situation (a situation around the periphery of the host vehicle) of the road (lane markings Lm) with the vehicle position in the direction in which the host vehicle 10 is traveling serving as a reference, which is generated by combining the host vehicle state information Ivh and the external environment recognition information Ipr.

Returning to FIG. 1, responsive to the operation command Ae from the integrated control unit 70, the target trajectory generating unit 73 refers to the environment map information Iem (including the dynamic external environment recognition information Iprd and the static external environment recognition information Iprs), the host vehicle state information Ivh, and a road map (curvature of curves and the like) that is stored in the map information storage unit 42, generates the target trajectory St corresponding to the vehicle dynamics of the host vehicle 10 in the operation cycle Toc, outputs the target trajectory St to the integrated control unit 70, and simultaneously outputs it to the vehicle control unit 110. The target trajectory St is stored as trajectory information It in a trajectory information storage unit 48.

In this manner, the target trajectory generating unit 73 generates in the operation cycle Toc the target trajectory (referred to as a 1-sec trajectory) St corresponding to a relatively short time period (short distance) to be traveled henceforth, for example, a travel time period on the order of one second.

As the target trajectory St, at each instance of the operation cycle Toc, there is generated a trajectory point sequence Pj(x, y, θz, vs, va, δst) as vehicle command values, generally on the basis of the position x in the longitudinal direction along the center line CL of the lane markings, the position y in the lateral direction, the posture angle θz, the speed vs, the acceleration va, and the steering angle δst (the steering angle δ of the vehicle 10 can be calculated in consideration of a gear ratio to the steering angle δst of the steering wheel), etc., {refer to the above-described equation (2)}.

A plurality of trajectory candidate point sequences Pcj (operation cycle: about Toc/5) are generated by the target trajectory generating unit 73 in each of the operation cycles Toc, however, as will be described later, the generated trajectory candidate point sequences Pcj are further evaluated by the target trajectory generating unit 73 on the basis of the vehicle dynamics, and thereafter, according to the evaluation results, corrections are made if necessary, and the trajectory point sequence Pj is generated as an output trajectory of the target trajectory St.

Moreover, in the later-described second exemplary embodiment, at the time of switching from the manual driving mode to the automated driving mode, the target trajectory generating unit 73 outputs to the vehicle control unit 110 a trajectory point sequence Pj made up from a predicted trajectory Pt on the basis of the most recent vehicle state information Ivh.

The vehicle control unit 110 converts the trajectory point sequence Pj into the vehicle control values Cvh, and outputs the values to the driving force device 28, the steering device 30, and the braking device 32, in a manner so that the vehicle 10 travels along the input target trajectory St (or alternatively, the predicted trajectory Pt), and more specifically, along the trajectory point sequence Pj that was generated and input on the order of the operation cycle Toc/5 (a by-five-division in which the operation cycle Toc is divided into five segments).

### Description of Operations of Embodiments

### [First Exemplary Embodiment]: St Generation Mode (Target Trajectory Generation Mode)

### Description of First Exemplary Embodiment According to Flowchart

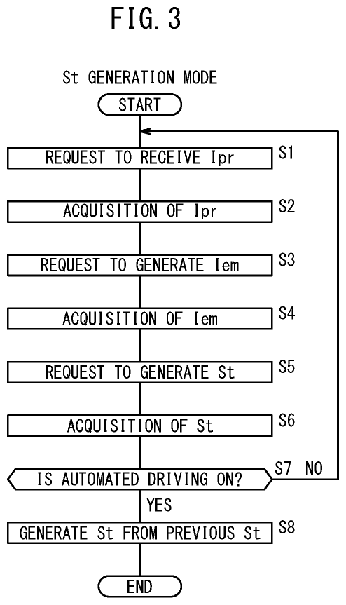

According to the first exemplary embodiment, operations of the vehicle control device 12, which is basically configured in the manner described above, will be described in detail with reference to the flowchart of FIG. 3. The execution subject of the program according to the flowchart is the integrated control unit 70 of the vehicle control device 12.

In the St generation mode (target trajectory generation mode) according to the first exemplary embodiment, in comparison with a later-described Pt generation mode (predicted trajectory generation mode) according to the second exemplary embodiment, the amount of power consumption for the purpose of calculations performed during non-automated driving is large, and therefore, for example, the St generation mode is executed in the case that the residual capacity SOC of the power storage device 124 as detected by the residual capacity sensor 122 is greater than a threshold residual capacity value SOCth (SOC>SOCth).

In step S1, the integrated control unit 70 transmits with respect to the recognition result receiving unit 52 the operation command Aa to request reception of the external environment recognition information Ipr.

In this case, in a time period that is less than the operation cycle Toc, and on the basis of the external environmental information (image information) from the cameras 33 from among the external environment sensors 14, the external environment recognition unit 51 recognizes the lane markings Lm (Lmr, Lml) on both sides (right and left sides) of the vehicle 10, and together therewith, generates the static external environment recognition information Iprs of features such as the position up to a stop line of an intersection or the like, and the travel capable region (a region in which guardrails and curbsides are excluded), etc., and transmits the information to the recognition result receiving unit 52.

Simultaneously, on the basis of the external environmental information from the cameras 33, the radar devices 34, and the non-illustrated LIDAR devices or the like, the external environment recognition unit 51 generates the dynamic external environment recognition information Iprd of features such as obstacles (including parked or stopped vehicles), traffic participants (people, other vehicles), and the colors of traffic signals, etc., and transmits the information to the recognition result receiving unit 52.

Therefore, in step S2, the static external environment recognition information Iprs (for example, mainly road partition lines such as lane markings, stop lines, and curbsides) and the dynamic external environment recognition information Iprd (for example, mainly colors of traffic signals, and traffic participants) are acquired in synchronism with the operation command Aa as the external environment recognition information Ipr by the integrated control unit 70 through the recognition result receiving unit 52, and such information is stored in the storage device 40.

In step S3, in synchronism with the operation cycle Toc, the integrated control unit 70 transmits with respect to the environment map generating unit 54 the external environment recognition information Ipr and the host vehicle state information Ivh, and together therewith, transmits the operation command Ab to request generation of the environment map information Iem.

In synchronism with the operation command Ab, and within the operation cycle Toc, the environment map generating unit 54 combines (merges) the host vehicle state information Ivh with the external environment recognition information Ipr, generates the environment map information Iem including the environment map Lmap shown in FIG. 3, and transmits the same to the integrated control unit 70.

Consequently, in step S4, the integrated control unit 70 acquires the environment map information Iem and stores it in the storage device 40.

Next, in step S5, in synchronism with the operation cycle Toc, the integrated control unit 70 transmits with respect to the target trajectory generating unit 73 the external environment recognition information Ipr, the host vehicle state information Ivh, and the environment map information Iem, and together therewith, transmits the operation command Ae to request generation of the target trajectory St.

In synchronism with the operation command Ae, the target trajectory generating unit 73 sets to an initial value (initial position) the previously output target trajectory St, and based on the initial value (initial position), with reference to the host vehicle state information Ivh and the environment map information Iem, generates the trajectory candidate point sequences Pcj including a nose direction (longitudinal direction x) nd at each ⅕ of the operation cycle Toc (the operation cycle Toc divided by 5), and position coordinates (x, y) of the reference point Bp (FIG. 2) of the vehicle 10 in a direction (lateral direction y) perpendicular to the nose direction nd.

The target trajectory generating unit 73, while taking into consideration the vehicle dynamics in light of the environment map information Iem, evaluates whether the trajectories of the generated trajectory candidate point sequences Pcj, for example, are capable of enabling passage through an intersection in the case that the illuminated color of the traffic signal is green, or are capable of enabling stopping at a stop line before reaching the intersection in the case that the illuminated color of the traffic signal is red, or the like, corrects the trajectory candidate point sequences Pcj until the evaluation result thereof becomes an affirmative evaluation, and generates the trajectory point sequence Pj which is the output trajectory. The generated trajectory point sequence Pj is transmitted to the integrated control unit 70 and the vehicle control unit 110.

In step S6, the target trajectory St made up from the trajectory point sequence Pj, and an updated count value of an update counter are acquired by the integrated control unit 70, and are stored as trajectory information It in the trajectory information storage unit 48.

Next, in step S7, the integrated control unit 70 determines whether or not the automated driving switch 22 is set to an on-state automated driving mode.

In the case that the automated driving switch 22 is set to an off-state non-automated driving mode (step S7: NO), the process of generating the target trajectory St of step S1 and thereafter is repeated.

In the case that the automated driving switch 22 is set to the on-state automated driving mode (step S7: YES), then in step S8, by transmitting an automated driving start command Adcom to the vehicle control unit 110, the vehicle 10 switches smoothly and instantaneously to the automated driving mode {also referred to as transitioning (switching over) from the non-automated driving mode to the automated driving mode}.

Then, in step S8, the target trajectory St, which is made up from the previous instance of the trajectory point sequence Pj generated in step S6, is output from the target trajectory generating unit 73 to the vehicle control unit 110. Consequently, the vehicle control values Cvh corresponding to the trajectory point sequence Pj of the target trajectory St are output from the vehicle control unit 110 to actuators 27 (the driving force device 28, the steering device 30, and the braking device 32), and automated driving on the basis of the target trajectory St is started or continued.

### Description of First Exemplary Embodiment in Accordance with Time Chart

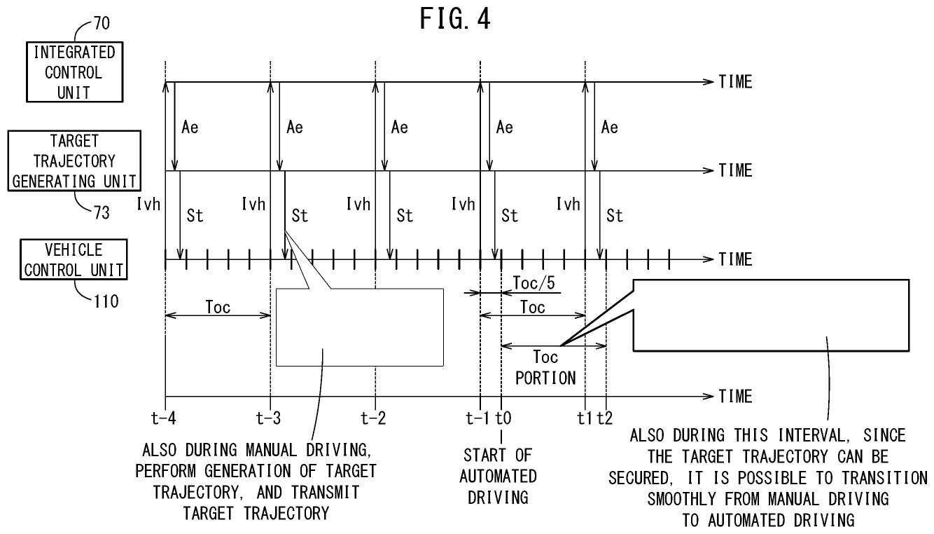

Next, with reference to the time chart of FIG. 4, an operation of transitioning from the non-automated driving mode to the automated driving mode will be described.

In FIG. 4, at time t0, the manual driving mode (automated driving OFF state) is switched to the automated driving mode (automated driving ON state) by an operation of the automated driving switch 22 made by the driver or the like.

At time t−4 prior to time t0 (at the start timing of the operation cycle Toc (=first period) which is a point in time at the leftmost end in FIG. 4), the integrated control unit 70 receives the host vehicle state information Ivh from the vehicle control unit 110.

In the vicinity of the start of the operation cycle Toc from the time t−4, the integrated control unit 70 transmits with respect to the target trajectory generating unit 73 the operation command Ae to request generation of the target trajectory St (corresponding to step S5).

In response to the operation command Ae, the target trajectory generating unit 73 generates the target trajectory St, which is made up from the trajectory point sequence Pj, at a time within substantially Toc×(⅕) within the operation cycle Toc, and outputs the generated target trajectory St to the integrated control unit 70 and the vehicle control unit 110.

In this manner, during the manual driving mode in which switching is not made to the automated driving mode, generation of the target trajectory St which is made up from the trajectory point sequence Pj is carried out at times t−4, t−3, and t−2, and also at time t−1, and the generated target trajectories St are transmitted to the vehicle control unit 110.

At time t0, a switch is made to the automated driving mode (automated driving ON state) by an operation of the automated driving switch 22.

At this point in time t0, since the target trajectory St generated previously in the vicinity of time t−2 can be secured, it is possible to smoothly and instantaneously transition from manual driving to automated driving.

Moreover, at time t1 after automated driving has started, the target trajectory generating unit 73 receives from the integrated control unit 70 the fact that the automated driving mode has been initiated, and at the next time t2, the target trajectory St generated by the target trajectory generating unit 73 from the occurrence of the automated driving mode is output to the vehicle control unit 110.

In this manner, according to the first exemplary embodiment, even if the automated driving mode has not been initiated (prior to time t0), generation of the target trajectory St which is made up from the trajectory point sequence Pj is continuously performed by the target trajectory generating unit 73 on the basis of the environment map information Iem and the most recent vehicle state information Ivh. As a result, even if a communication delay or an operation time delay occurs, during such a time period, the target trajectory St which is made up from the trajectory point sequence Pj is transmitted to the vehicle control unit 110. Therefore, during traveling, when transitioning from manual driving to automated driving, the vehicle 10 can initiate automated driving smoothly and instantaneously.

### [Second Exemplary Embodiment]: Pt Generation Mode (Predicted Trajectory Generation Mode)

### Description of Second Exemplary Embodiment According to Flowchart

In the Pt generation mode (predicted trajectory generation mode) according to the second exemplary embodiment, in comparison with the St generation mode (target trajectory generation mode) according to the first exemplary embodiment, the amount of power consumption for the purpose of calculations performed during non-automated driving is small, and therefore, for example, the Pt generation mode is executed in the case that the residual capacity SOC of the power storage device 124 as detected by the residual capacity sensor 122 is less than or equal to the threshold residual capacity value SOCth (SOC≤SOCth).

In step S11, the integrated control unit 70 transmits the most recent vehicle state information Ivh to the target trajectory generating unit 73, and causes the target trajectory generating unit 73 to generate the predicted trajectory Pt. The generated predicted trajectory Pt is transmitted to the vehicle control unit 110.

In this case, in synchronism with the operation cycles Toc, and at each instance of the operation cycle Toc, the predicted trajectory Pt is generated for a predetermined time period Tpt portion, for example, for an operation cycle Toc×3 (Tpt=3×Toc) portion.

On the basis of the host vehicle state information Ivh of the most recent vehicle state, and in particular, based on the speed vs, the acceleration Va, and the steering angle δst, the predicted trajectory Pt linearly predicts the host vehicle state after the predetermined time period Tpt (determined by experiment or simulation) in consideration of a communication delay and an operation time delay, and because it is an intervening connecting trajectory, at a predicted time point, although the trajectory coincides with the most recent host vehicle state information Ivh, since it is not a target trajectory St made up from a trajectory point sequence Pj by which the vehicle 10 can travel forward using the environment map information Iem, it should be noted that as time passes, the predicted trajectory Pt deviates from the actual vehicle state (referred to herein as an ideal trajectory Pideal) of the vehicle 10.

Next, in step S12, the integrated control unit 70 determines whether or not the automated driving switch 22 is set to the on-state automated driving mode.

In the case that the automated driving switch 22 is set to the off-state non-automated driving mode (step S12: NO), the process of generating the predicted trajectory Pt of step S11 is repeated. In this manner, by performing the process of generating the predicted trajectory Pt at each instance of the operation cycle Toc, at least at the point in time when the predicted trajectory Pt is generated, the predicted trajectory Pt is reset to the ideal trajectory pideal which is consistent with the travel trajectory of a model driver or the like.

In the case that the automated driving switch 22 is set to the automated driving mode (step S12: YES), then in step S13, even if the residual capacity SOC of the power storage device 124 is less than or equal to the threshold residual capacity value SOCth, the integrated control unit 70 releases this restriction, together with transmitting the operation commands Aa, Ab, and Ae respectively to the recognition result receiving unit 52, the environment map generating unit 54, and the target trajectory generating unit 73.

In step S14, by transmitting the automated driving start command Adcom to the vehicle control unit 110, the vehicle 10 is switched to the automated driving mode (also referred to as transitioning from the non-automated driving mode to the automated driving mode).

Consequently, by the vehicle control unit 110 outputting to the actuators 27 (the driving force device 28, the steering device 30, and the braking device 32) the vehicle control values Cvh corresponding to the predicted trajectory Pt (generated in step S11) that was predicted from the most recent host vehicle state information Ivh, it is possible to smoothly and instantaneously transition from manual driving to automated driving.

Next, in step S15, based on the transmission of the operation commands Aa, Ab, and Ae in step S13, it is confirmed whether or not the target trajectory St has been generated, and until the target trajectory St is generated (step S15: NO), automated driving in accordance with the predicted trajectory Pt is continued, whereas after the target trajectory St has been generated (step S15: YES), automated driving on the basis of the target trajectory St is performed.

### Description of Second Exemplary Embodiment in Accordance with Time Chart

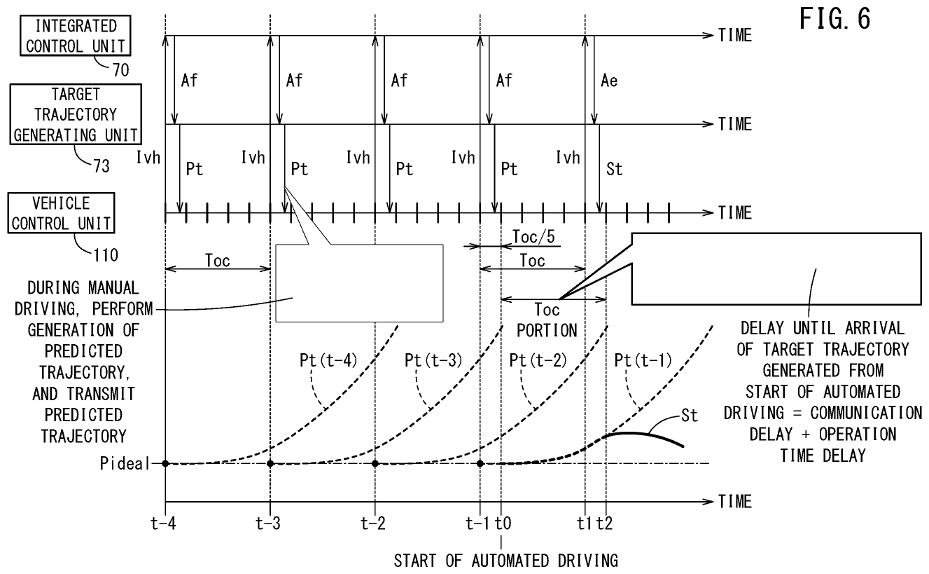

Next, with reference to the time chart of FIG. 6, an operation of transitioning from the non-automated driving mode to the automated driving mode will be described. In the time chart of FIG. 6, the same reference characters are applied to time points corresponding to the time points shown in the time chart of FIG. 4.

In this instance, the time chart on the lower side in FIG. 6 is a conceptual diagram showing an amount of shifting (deviation) of the predicted trajectory Pt from the ideal trajectory Pideal.

In FIG. 6, at time to, a switch is made to the automated driving mode (automated driving ON state) by an operation of the automated driving switch 22 (corresponding to step S12: YES).

In this case, at time t−4, time t−3, time t−2, and time t−1, there are generated, respectively, the predicted trajectory Pt(t−4), the predicted trajectory Pt(t−3), the predicted trajectory Pt(t−2), and the predicted trajectory Pt(t−1).

At the point in time when the predicted trajectory Pt is generated, although the predicted trajectory Pt is reset and coincides with the ideal trajectory Pideal, the deviation from the ideal trajectory Pideal increases as time passes from the time of generation thereof.

When automated driving is started at time t0, the predicted trajectory Pt(t−1) is applied during the period until time t2, from time t0 until time t2 when the target trajectory St is applied, and automated driving is continued on the basis of the predicted trajectory Pt(t−1).

In the vicinity of time t1, the integrated control unit 70 transmits to the recognition result receiving unit 52, the environment map generating unit 54, and the target trajectory generating unit 73, respectively, the operation command Aa to request generation of the external environment recognition information Ipr, the operation command Ab to request generation of the environment map information Iem, and the operation command Ae to request generation of the target trajectory St (corresponding to step S13).

In response to these requests, the target trajectory generating unit 73 transmits the target trajectory St generated immediately prior to time t2 to the integrated control unit 70 and the vehicle control unit 110.

Consequently, after time t2, the predicted trajectory Pt for the vehicle 10 is switched to the target trajectory St that approaches the ideal trajectory Pideal.

In this manner, according to the second exemplary embodiment, even in a state in which the automated driving mode is not initiated, generation of the predicted trajectory Pt is continuously carried out in the target trajectory generating unit 73 on the basis of the most recent host vehicle state information Ivh. As a result, even if a communication delay or an operation time delay occurs, during such a time period, the predicted trajectory Pt is transmitted to the vehicle control unit 110. Therefore, during traveling, when transitioning from manual driving to automated driving, the vehicle 10 can initiate automated driving smoothly and instantaneously.

### SUMMARY

As has been described above, according to the aforementioned embodiments, the vehicle control device 12, which controls the vehicle 10 that is capable of being driven automatically, is equipped with the environment map generating unit (local environment map generating unit) 54 configured to generate the environment map information (local environment map information) Iem based on the external environment recognition information Ipr and the host vehicle state information Ivh, the target trajectory generating unit 73 configured to generate, based on the host vehicle state information Ivh and the environment map information Iem, the target trajectory St within the operation cycle (first period) Toc, and which is made up from the trajectory point sequence Pj of the second period (Toc/5) which is a divided portion of the operation cycle (first period) Toc, the vehicle control unit 110 configured to perform automated driving based on the target trajectory St, or to perform manual driving in accordance with driver operations, the automated driving switch 22 as an automated/manual switching unit configured to switch between automated driving and manual driving, and the integrated control unit 70 configured to control these elements.

In this case, during traveling of the host vehicle 10, and after the end timing of the second period (Toc/5) when switching from manual driving to automated driving is detected (at time t0 in FIGS. 4 and 6), the integrated control unit 70 is configured to implement a control so as to perform automated driving in accordance with the predicted trajectory Pt based on the previous instance of the target trajectory St portion or based on the most recent host vehicle state information Ivh until the end timing (at time t2 in FIGS. 4 and 6) of the operation cycle (first period) Toc, and after the end timing (time t2) of the operation cycle (first period) Toc portion, implement a control so as to perform automated driving along the target trajectory St which is sequentially generated.

According to the present embodiment, during traveling, when a switch is made from manual driving (the automated driving OFF state) to automated driving (the automated driving ON state) by the automated driving switch 22, the transition to automated driving in accordance with the predicted trajectory Pt is made based on the previous instance of the target trajectory St generated from the automated driving OFF state or the most recent host vehicle state information Ivh, and therefore, when transitioning from manual driving to automated driving, the transition can be made smoothly and instantaneously.

In this case, when a configuration is provided (see FIGS. 3 and 4) in which the target trajectory generating unit 73 is configured to continuously generate the target trajectory St regardless of switching between automated and manual driving, at a time of switching from manual driving to automated driving, and after the end timing (time t0) of the second period (Toc/5) and until the end timing (time t2) of the operation cycle (first period=Toc) portion (Toc portion), the integrated control unit 70 may be configured to implement a control so as to perform automated driving using the remaining portion of the target trajectory St that was calculated in the operation cycle (first period) Toc, and after the end timing (time t2) of the operation cycle (first period, Toc) portion (Toc portion), may implement a control so as to perform automated driving along the target trajectory St which is sequentially generated.

In this manner, at the time of switching from manual driving to automated driving, the transition is made immediately to automated driving in accordance with the previously calculated target trajectory St, and therefore, when transitioning from manual driving to automated driving, the transition can be made smoothly and instantaneously.

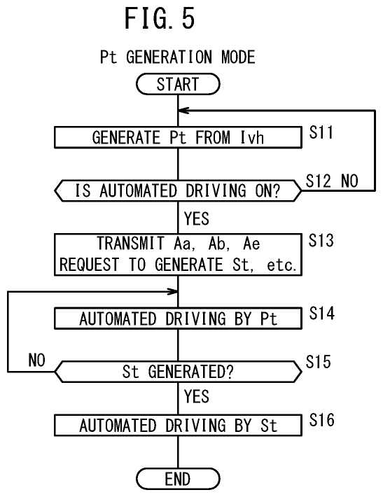

Further, when a configuration is provided (see FIGS. 5 and 6) in which, before switching to automated driving, the target trajectory generating unit 73 is configured to continuously generate the predicted trajectory Pt based on the most recent host vehicle state information Ivh, and after switching to automated driving, continuously generate the target trajectory St, then at a time of switching from manual driving to automated driving, and after the end timing of the second period (Toc/5) and until the end timing (time t2) of the operation cycle (first period, Toc) portion (Toc portion), the integrated control unit 70 may be configured to initiate automated driving in accordance with the predicted trajectory Pt generated based on the most recent host vehicle state information Ivh, and after the end timing (time t2) of the operation cycle (first period, Toc) portion (Toc portion), may implement a control to continue with automated driving in accordance with the target trajectory St.

In this manner, at the time of switching from manual driving to automated driving, automated driving is initiated in accordance with the predicted trajectory Pt generated based on the most recent host vehicle state information Ivh, and thereafter, automated driving is continued in accordance with the target trajectory St. Therefore, when transitioning from manual driving to automated driving, the transition can be made smoothly and instantaneously.

Moreover, by setting the predicted trajectory Pt to a portion that anticipates the time delay corresponding to at least the operation cycle (first period, Toc) portion, automated driving in accordance with the target trajectory St can be continued thereafter.

In the present embodiment, there is further provided the power storage device 124 configured to supply electrical power to the vehicle control device 12. In the case that the residual capacity SOC of the power storage device 124 is greater than or equal to the threshold residual capacity value SOCth, the vehicle control unit 110 is configured to initiate automated driving based on the target trajectory St, and in the case of the residual capacity SOC being less than the threshold residual capacity value SOCth, preferably initiate automated driving based on the predicted trajectory Pt.

In this manner, in the case that the residual capacity SOC of the power storage device 124 is greater than or equal to the threshold residual capacity value SOCth and there is a surplus of electrical power, the target trajectory St is generated at all times during traveling, whereas in the case that the residual capacity SOC of the power storage device 124 is less than the threshold residual capacity value SOCth and there is not a surplus of electrical power, continuous generation of the target trajectory St is prohibited. Therefore, automated driving can be performed in accordance with the residual capacity SOC of the power storage device 124. Moreover, when switching is carried out, performance of automated driving with the most recent target trajectory St enables the trajectory of the vehicle to be smoother in comparison to performing automated driving with the predicted trajectory Pt based on the most recent host vehicle state information Ivh.

The present invention is not limited to the embodiment described above, and it goes without saying that various configurations could be adopted therein based on the descriptive content of the present specification.

1. A vehicle control device, comprising:
an environment map generating unit configured to generate environment map information based on external environment recognition information and host vehicle state information;
a target trajectory generating unit configured to generate, based on the host vehicle state information and the environment map information, a target trajectory within a first period, and which is made up from a trajectory point sequence of a second period which is a divided portion of the first period;
a vehicle control unit configured to perform automated driving based on the target trajectory, or to perform manual driving in accordance with driver operations;
an automated/manual switching unit configured to switch between automated driving and manual driving; and
an integrated control unit configured to control these elements;
wherein, during traveling of the host vehicle, and after an end timing of the second period when switching from manual driving to automated driving is detected, the integrated control unit is configured to implement a control so as to perform automated driving in accordance with a predicted trajectory based on a previous instance of the target trajectory or based on most recent host vehicle state information until an end timing of the first period portion, and after the end timing of the first period portion, implement a control so as to perform automated driving along the target trajectory which is sequentially generated.

2. The vehicle control device according to claim 1, wherein:
the target trajectory generating unit is configured to continuously generate the target trajectory regardless of switching of the automated/manual switching unit; and
at a time of switching from manual driving to automated driving, and after the end timing of the second period and until the end timing of the first period portion, the integrated control unit is configured to implement a control so as to perform automated driving using a remaining portion of the target trajectory that was calculated in the first period, and after the end timing of the first period portion, implement a control so as to perform automated driving along the target trajectory which is sequentially generated.

3. The vehicle control device according to claim 1, wherein:
before switching to automated driving by the automated/manual switching unit, the target trajectory generating unit is configured to continuously generate the predicted trajectory based on the most recent host vehicle state information, and after switching to automated driving, continuously generate the target trajectory; and
at a time of switching from manual driving to automated driving, and after the end timing of the second period and until the end timing of the first period portion, the integrated control unit is configured to initiate automated driving in accordance with the predicted trajectory, and after the end timing of the first period portion, implement a control to continue with automated driving in accordance with the target trajectory.

4. The vehicle control device according to claim 3, wherein the predicted trajectory is a portion in which a time delay corresponding to at least the first period portion is expected.

5. The vehicle control device according to claim 1, further comprising:
a power storage device configured to supply electrical power to the vehicle control device;
wherein, in a case that a residual capacity of the power storage device is greater than or equal to a threshold residual capacity value, the vehicle control unit is configured to initiate automated driving based on the target trajectory, and in a case that the residual capacity is less than the threshold residual capacity value, the vehicle control unit is configured to initiate automated driving based on the predicted trajectory.
